(19) United States
(12) Patent Application Publication
(10) Pub. No.: US 2016/0275059 A1
(43) Pub. Date: Sep. 22, 2016

(54) SYSTEM AND METHOD FOR PARALLEL CONTRACT AUTHORING

(71) Applicants: Smriti Taparia, Mumbai (IN); Nikhil Mishra, Mumbai (IN); Kanishka Ghosh, Mumbai (IN)

(72) Inventors: Smriti Taparia, Mumbai (IN); Nikhil Mishra, Mumbai (IN); Kanishka Ghosh, Mumbai (IN)

(21) Appl. No.: 15/063,032

(22) Filed: Mar. 7, 2016

(30) Foreign Application Priority Data
Mar. 19, 2015 (IN) 904/MUM/2015

(51) Int. Cl. G06F 17/24; G06F 17/22; G06Q 50/18

(52) U.S. Cl. CPC G06F 17/241; G06Q 50/188; G06F 17/2288

(57) ABSTRACT

A system and method is described wherein multiple users have provisions to author and review contract documents. A computer based system for plurality of parallel contract reviewing is provided. The system comprises a processor unit and a computer readable medium storing instructions executable by the processor unit to perform the step of inserting the contract marks in terms of bookmarks for all the extracted clauses of the documents. The tool reads the documents in terms of bookmarks. A bookmark identifies a location or a selection of text that a user may name and identify for future reference. For example, a user might use a bookmark to identify text that another user wants to revise at a later time. Likewise, for every contract document, the tool automatically places bookmarks so that every section and clause can be identified in terms of different bookmarks.

### CROSS-REFERENCE TO RELATED APPLICATION

The instant application claims priority to Indian Patent Application Serial No. 904/MUM/2015, filed Mar. 19, 2015, pending, the entire specification of which is expressly incorporated herein by reference.

### FIELD OF THE INVENTION

The invention relates in general to electronic file management and more specifically to a method, apparatus and system for drafting, negotiating, and managing contracts through multiple user terminals for parallel contract authoring. The present invention provides such techniques wherein multiple users have provisions to author the contracts.

### BACKGROUND OF THE INVENTION

Contracts are often required in business-to-business transactions. As merely an example, contracts are often required during the procurement of materials and services. As another example, contracts are often required during the sales process.

Individuals, companies, and a variety of organizations enter into and perform legal contracts. Often, the negotiating process leading to an acceptable and executed contract between two or more parties is lengthy and generates a number of contract revisions. Comments are regularly used during negotiation to convey reasons for adding language to, or deleting language from, a contract, to convey concerns regarding the consequences of portions of the contract and to convey other concerns or issues. The comments may be directed to the parties of the contract, members negotiating on one side of an agreement, or to select members of one or both groups. Conventional methods for tracking, archiving and communicating contract revisions and other information include paper document storage and dissemination as well as digital data storage and transmission. For example, paper copies of contract revisions and executed contracts can be mailed through the postal service sent using a courier service or directly exchanged between parties of members of a party. Paper copies can be stored in a file cabinet. Other conventional techniques of sharing information regarding contracts include transmission via facsimile and email. Also, contracts and other related documents can be stored in digital form in databases and on digital storage media such as computer hard drives, CDROMS and memory diskettes.

Once a contract has been negotiated and executed, conventional management of contracts and related files is limited in several ways, however. In this regard, management of a contract refers not only to maintenance and archiving of documents, but also to supervision of performance required by the contract, and verification of scheduled events. Large organizations often have a large number of executed contracts and contract templates or forms. Management of these and other relevant documents is difficult and results in errors. Original executed documents are typically stored in a file cabinet making it difficult for personnel to quickly determine if a contract exists, who executed the contract, when the contract was executed, the terms of the contract, and whether the terms are different from the preferred form used by the organization. Further, where similar forms or templates exist, conventional contract management techniques often do not provide adequate information indicating what circumstances warrant using one template over another, which provisions in these templates are considered to be negotiable, and what the preferred negotiating strategies are. Moreover, the monitoring and reporting of performance, schedules, and milestones is usually performed using manual means that are separate from the documents that memorialize a contract.

The process of creating, negotiating, and managing contracts is intensely collaborative, especially as concerns the creation of an initial set of contract documents and the negotiation of the terms, conditions, and language of a contract. Historically, collaboration has been realized by physical proximity-meeting in the same room, using the same filing cabinets and by maintaining multiple, parallel files, with drafts, exhibits, and other related documents. Modern technology which affords parallel multi-user access to meeting, database and version control functions enhances the ability of teams to work collaboratively in the creation and negotiation of contracts.

Although U.S. Pat. No. 8,954,389 disclosed a system and method of contract authoring, it did not address the challenges currently faced by the users of contract management software tools, that is, the parallel review of the same contract document is not possible simultaneously by different reviewers of the same contract document. A contract document might be required to be reviewed by multiple reviewers so that when a contract document is entered into, the tool, after extraction of clauses, all the reviewers cannot work simultaneously on the same document. When one reviewer has accessed that document, the other reviewers are required to remain in queue, unless the first reviewer is done with the review and checks out from the contract document. Then, only the second reviewer of the same contract document can access the document for making edits. Thus, there is loss of time of the users in completing the review of the document one by one as it takes lot of time.

Thus, there exists a need to have system and method of parallel/simultaneous review of the same contact document by multiple reviewers/users.

### SUMMARY OF THE INVENTION

The main object of the present invention is to provide a system and method for parallel/simultaneous review of the same contact document by multiple reviewers/users.

Yet another object of the present invention is to provide a system and method to eliminate the challenges wherein a contract document might be required to be reviewed by multiple reviewers so when a contract document is entered into the tool after extraction of clauses, all the reviewers cannot work simultaneously on the same document.

It is an object of the present invention to provide a system and method that saves the time in review process by multiple users on the same document or documents.

In accordance with illustrative embodiment of the present invention, a computer based system for parallel contract reviewing is provided, comprising:

a processor unit;

a computer readable medium storing instructions executable by the processor unit to perform the steps of:

inserting a bookmark for each extracted clause relating to a contract document, wherein a bookmark identifies a location or a selection of text labelled by a user; and

reading and reviewing the bookmarks by plurality of reviewers.

In accordance with one aspect of the illustrative embodiment of the present invention, wherein each of the clauses assigned to each of the reviewers is labelled by a same identification as the reviewer of the document is identified, such that the system can recognize each reviewer for each of the bookmarks.

In accordance with one aspect of the illustrative embodiment of the present invention, wherein, with each new version of the same contract document, a bookmarked portion is highlighted while the rest of the document is marked non-editable.

In accordance with one aspect of the illustrative embodiment of the present invention, wherein the system has a tool that performs functions selected from the group consisting of auto-checking the document and returning it to the marked reviewer, enabling the reviewers to edit the document by adding or deleting texts post receiving the document that can then be returned through the tool, identifying the edited segments of the document labelled by the user and recognising the reviewer of each of the edited documents, identifying the user with the aid of login credentials and the portion of the document that is assigned to the user, which is translated via the bookmarked portions assigned, wherein the portion is identified through the bookmarks in which the steps are repeated for a plurality of reviewers with the plurality of clauses of the contracts, and aids in merging the edited versions of the said bookmark segments, made by the each of the reviewers, with the original contract document such that any changes to the content of the bookmarks assigned to each of the reviewers of the existing document is replaced by the content of the new edits that the user puts into the tool that creates a new version of the document, wherein all the changes made by the users are incorporated.

In accordance with one aspect of the illustrative embodiment of the present invention, wherein each of the reviewers for multiple documents repeats the process for each edit and the process is performed in a parallel fashion with the help of the tool, which merges all changes into the main contract document.

These and other objects and advantages of the present invention will become apparent from a reading of the following specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### DETAILED DESCRIPTION OF THE INVENTION

The subject invention will be described with reference to numerous details set forth below, and the accompanying drawings will illustrate the invention. The following description and drawings are illustrative of the invention and are not to be construed as limiting the invention. Numerous specific details are described to provide a thorough understanding of the present invention. However, in certain instances, well known or conventional details are not described in order to not unnecessarily obscure the present invention in detail.

In accordance to the present embodiment of the present invention, there is provided a system and method wherein multiple users have the ability to simultaneously author and/or review contract documents.

In a specific embodiment of the present invention, a computer based system for plurality of parallel and/or simultaneous contract reviewing is provided. The system comprises a processor unit. The system also comprises a computer readable medium storing instructions executable by the processor unit to perform the step of inserting the contract marks in terms of bookmarks for all the extracted clauses of the documents. The tool reads the documents in terms of bookmarks. A bookmark identifies a location or a selection of text that a user may name and identify for future reference. For example, a user might use a bookmark to identify text that another user may want to revise at a later time. Likewise, for every contract document, the tool automatically places bookmarks so that every section and clause can be identified in terms of different bookmarks.

In an embodiment of the present invention, when a clause is assigned to reviewer A, the text between the two bookmarks (e.g., a bookmark before the beginning and after the end of the clause) is tagged with identifying indicia (e.g., an “ID”) and referenced to a particular reviewer, i.e., reviewer A, that is tagged by the same ID, referenced and this is how the tool understands that the portion is to be sent out to reviewer A.

Further, the tool creates a new version of the contract document, and the bookmarked portion is highlighted. The rest of the document is marked as non-editable. This entire activity is performed by the tool. Thus, the document is auto-checked out by the tool and sent to the marked reviewer. Further, when reviewer A receives the document, he/she can make changes to the portion that is highlighted, add or delete text, and then check the revised document back into the tool. Subsequently, the tool identifies, e.g., from the user's credentials, tagging ID and the version document, that the reviewer that submitted the response is indeed reviewer A, and the portion bookmarked against him/her is also identified. Therefore, when the user logs in, his credentials are identified by the tool and along with that the tool also identifies which portion of the document is assigned to him/her. This is translated through the bookmarked portions assigned to the user. The portion is identified through the bookmarks wherein the steps are repeated for a plurality of multiple tagged reviewers with the plurality of clauses of the contracts.

In yet another embodiment of the present invention, the tool merges the changes between the bookmarked texts into the main contract document whose copy was used to create the document. However, the document that is checked in by the user, the content between the bookmarks assigned to him/her of the existing document is replaced by the content of the new document that he/she puts into the tool which further helps in creation of a new version of the document with changes of the user incorporated. Thus, the same bookmarked portion that was assigned to reviewer A is now replaced by the content of the document checked in by him/her.

In yet another embodiment of the present invention, wherein the process is repeated for all the reviewers' plurality of documents and thereby the process is completed in a parallel fashion with the tool merging changes into the main document.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld or mobile device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

As used herein, the term “mobile device” is intended to encompass any form of programmable computing device as may exist, or will be developed in the future, that implements a communication module for wireless voice and data communications, including, for example, cellular telephones, personal data assistants (PDA's), palm-top computers, laptop, and notebook computers, wireless electronic mail receivers (e.g., the BLACKBERRY™ and TREO™ devices), multimedia Internet enabled cellular telephones (e.g., the BLACKBERRY STORM™, and similar personal electronic devices that include a wireless communication module, processor and memory.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

While considerable emphasis has been placed herein on the structures and structural interrelationships between the component parts of the preferred embodiments, it will be appreciated that many embodiments can be made and that many changes can be made in the preferred embodiments without departing from the principals of the invention. These and other changes in the preferred embodiment as well as other embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. A computer based system for parallel contract reviewing, comprising:
a processor unit;
a computer readable medium storing instructions executable by the processor unit to perform the steps of:
inserting a bookmark for each extracted clause relating to a contract document, wherein a bookmark identifies a location or a selection of text labelled by a user; and
reading and reviewing the bookmarks by plurality of reviewers.

2. The system as claimed in claim 1, wherein each of the clauses assigned to each of the reviewers is labelled by a same identification as the reviewer of the document is identified, such that the system can recognize each reviewer for each of the bookmarks.

3. The system as claimed in claim 1, wherein, with each new version of the same contract document, a bookmarked portion is highlighted while the rest of the document is marked non-editable.

4. The system as claimed in claim 1, wherein the system has a tool that performs functions selected from the group consisting of auto-checking the document and returning it to the marked reviewer, enabling the reviewers to edit the document by adding or deleting texts post receiving the document that can then be returned through the tool, identifying the edited segments of the document labelled by the user and recognising the reviewer of each of the edited documents, identifying the user with the aid of login credentials and the portion of the document that is assigned to the user, which is translated via the bookmarked portions assigned, wherein the portion is identified through the bookmarks in which the steps are repeated for a plurality of reviewers with the plurality of clauses of the contracts, and aids in merging the edited versions of the said bookmark segments, made by the each of the reviewers, with the original contract document such that any changes to the content of the bookmarks assigned to each of the reviewers of the existing document is replaced by the content of the new edits that the user puts into the tool that creates a new version of the document, wherein all the changes made by the users are incorporated.

5. The system as claimed in claim 1, wherein each of the reviewers for multiple documents repeats the process for each edit and the process is performed in a parallel fashion with the help of the tool, which merges all changes into the main contract document.
